(19) United States
(12) Patent Application Publication
(10) Pub. No.: US 2023/0249267 A1
(43) Pub. Date: Aug. 10, 2023

(54) AUTOMATED SYSTEMS AND METHODS FOR POST-TENSION TENDON MANUFACTURE AND COILING

(71) Applicant: FELIX SORKIN, Stafford, TX (US)

(72) Inventor: FELIX SORKIN, Stafford, TX (US)

(21) Appl. No.: 18/107,792

(22) Filed: Feb. 9, 2023

Related U.S. Application Data
(60) Provisional application No. 63/308,256, filed on Feb. 9, 2022.
(60) Provisional application No. 63/402,239, filed on Aug. 30, 2022.

(51) Int. Cl. B23D 23/02; B23D 33/02; B23D 36/00; B25J 11/00; B25J 9/16; B65G 37/00; B65G 43/08

(52) U.S. Cl. CPC B23D 23/02; B23D 33/02; B23D 36/0091; B25J 11/005; B25J 9/1679; B65G 37/00; B65G 43/08

(57) ABSTRACT

Automated systems and processes for manufacturing post-tension tendons are provided. In one embodiment the system may comprise a conveyor configured to introduce a pre-determined length of a tendon into a tub; a cutter configured to cut the tendon when it meets the pre-determined length; and (c) a control unit configured for a user to input the pre-determined length and a pre-determined bundle diameter. The control until is typically operably connected to the cutter and to the tub. Advantageously, the tub is configured to coil the tendon to form a tendon bundle and tie the tendon bundle in the predefined bundle diameter. A movable seater station may be employed to fasten an anchor to one end of the strand and said seater station may be configured to move among two or more tubs. A manipulator may be employed to move and hang coiled tendons.

### CROSS-REFERENCE TO RELATED APPLICATIONS

This application claims priority to U.S. provisional application 63/308,256 filed Feb. 9, 2022 (121290-10) and U.S. provisional application 63/402,239 filed Aug. 30, 2022 (121290-102) which applications are incorporated herein by reference.

### FIELD OF THE DISCLOSURE

The present disclosure relates to automated systems and methods for manufacturing, coiling, cutting, and/or tying post-tension tendons. The tendons are useful in, for example, post-tension reinforcement of concrete elements.

### BACKGROUND AND SUMMARY

Post-tensioning is a reinforcement method employed often in, for example, slab-on-ground, elevated slab applications, and other construction. Post-tensioning uses tensioning to reinforce concrete after the concrete has been placed. Tendons are typically placed prior to concrete placement. Once the concrete reaches a specific initial compressive strength, the tendons are stressed to a specified force and anchored. The external compressive force makes the concrete more resistant to tensile stresses that may otherwise cause the concrete to pull apart and crack.

The tendons employed in post-tensioning are typically high strength steel strands that are comprised of a number of individual wires, e.g. seven, that spiraled together tightly. Once spiraled with the desired number of wires, diameter, and weight, the tendons are typically cut to desired length, coiled into a bundle, tied, and then transferred for storage manually. The manual labor employed is costly. In addition, coiling the tendons places stress on the tendon such that if it is accidentally or unintentionally uncoiled it poses a risk to the workers. The cutting of tendons comprising tightly coiled steel strands is also labor intensive and potentially dangerous.

It would be desirable to automate one or more aspects of the cutting, coiling, tying, or transfer of the tendons to save labor costs and/or increase worker safety. Advantageously, the present application pertains to systems and methods that automate the cutting, coiling, tying, and/or transfer of the tendons. In one embodiment the application pertains to an automated system for manufacturing post-tension tendons. The system comprises (a) a conveyor configured to introduce a pre-determined length of a tendon into a tub; (b) a cutter configured to cut the tendon when it meets the pre-determined length; and (c) a control unit configured for a user to input the pre-determined length and a pre-determined bundle diameter. The control until is operably connected to the cutter and to the tub. The tub is configured to coil the tendon to form a tendon bundle and tie the tendon bundle in the predefined bundle diameter.

### BRIEF DESCRIPTION OF THE DRAWINGS

Various embodiments of the present disclosure, together with further objects and advantages, may best be understood by reference to the following description taken in conjunction with the accompanying drawings.

FIG. 1 shows a view of automated tying, bundling, and hanging of tendons.

FIG. 2 shows a second view of automated tying, bundling, and hanging of tendons.

FIG. 3 shows a third view of automated tying, bundling, and hanging of tendons.

FIG. 4 depicts a front view of a cutting line.

FIG. 5 depicts a side view of a cutting line

FIG. 6 depicts a top view of a cutting line.

FIG. 7A depicts a schematic of a rollerbox.

FIG. 7B depicts a schematic of a line counter.

FIG. 7C depicts a schematic of a tub selector.

FIG. 8 depicts a side view of a representative horizontal payoff.

### DETAILED DESCRIPTION

The following description of embodiments provides a non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

The systems and methods disclosed herein generally relate to systems and methods for manufacturing post-tension tendons, comprising:

(a) a conveyor configured to introduce a pre-determined length of a tendon into a tub;
(b) a cutter configured to cut the tendon when it meets the pre-determined length;
(c) a control unit configured for a user to input the pre-determined length and a pre-determined bundle diameter wherein the control until is operably connected to the cutter and to the tub; and
wherein the tub is configured to coil the tendon to form a tendon bundle and tie the tendon bundle in the predefined bundle diameter.

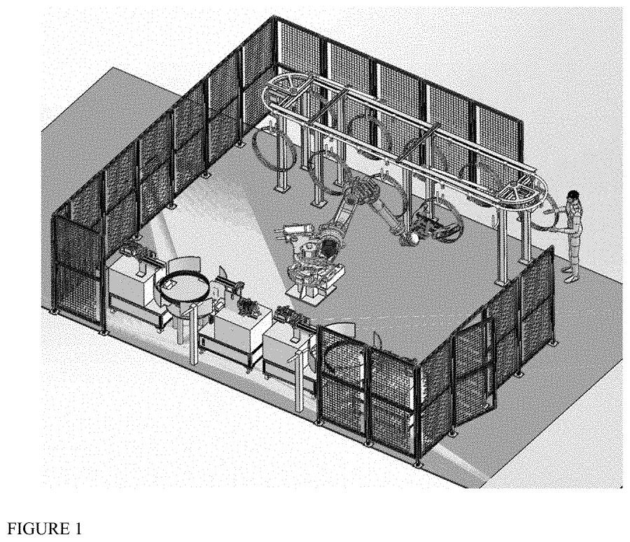

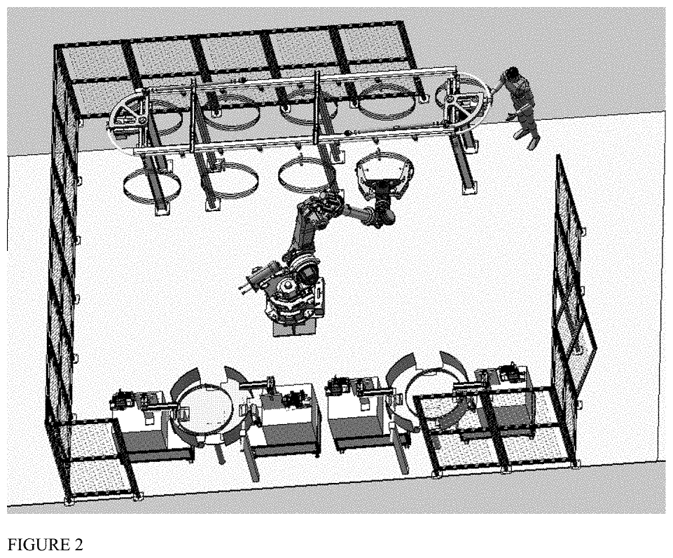

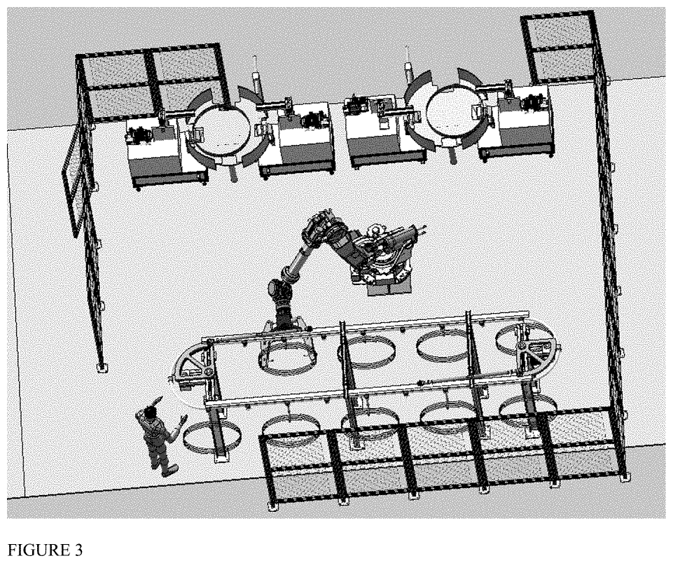

FIGS. 1-3 show representative embodiments wherein a conveyer provides the tendon into the tub wherein it is automatically coiled. It may be cut to desired length prior to the conveyer or on the conveyor. Once cut and coiled the tendon is tied into a bundle. The bundle may then be removed from the tub and hung or placed in storage by a robot as depicted or other automated mechanism.

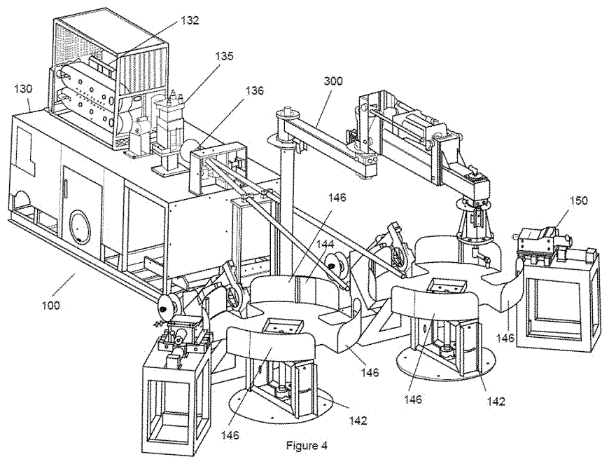

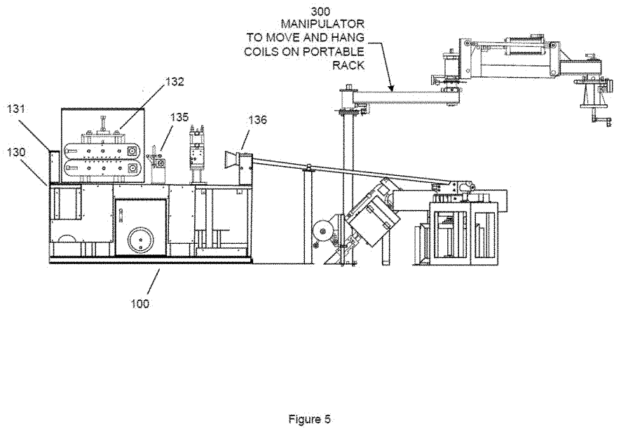

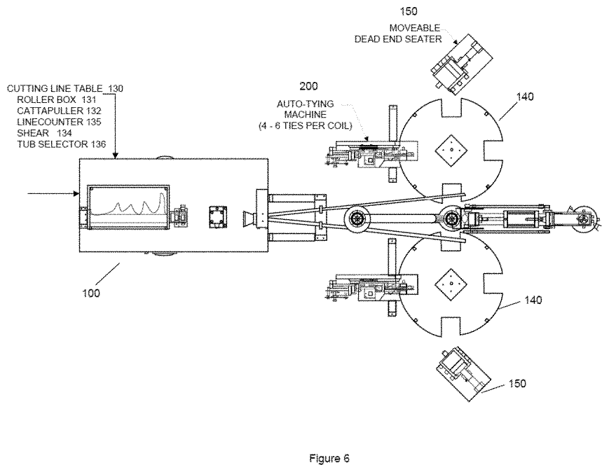

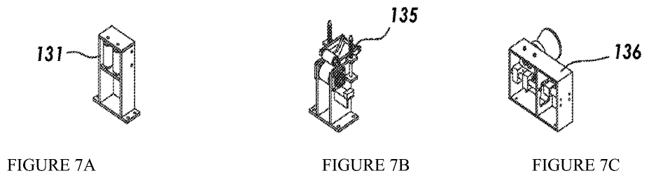

FIGS. 4-8 depict embodiments of a representative two tub cutting line with a horizontal payoff.

In preparing a strand for post-tensioning, a mill may supply a spool of cable. The cable may be single or multi-strand. For example, the mill may extrude the cable, apply grease, and sheathing, and coil. Certain embodiments of the present disclosure are directed to an automated cutting line for forming a strand from the spool supplied by the mill using a moveable dead end seater and/or an automated manipulator to move and hang coils on a portable rack.

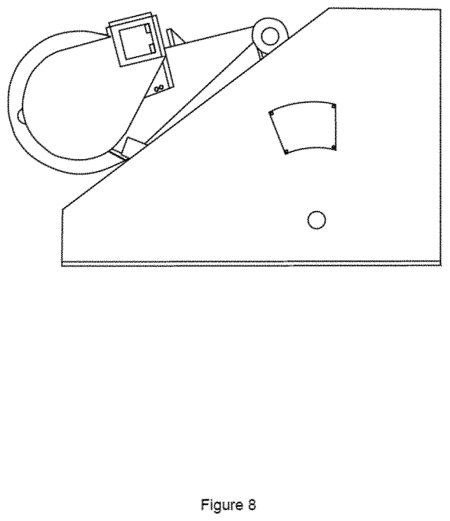

FIGS. 4-6 depict front, side, and top views respectively of a cutting line 100 with a horizontal payoff. Horizontal payoff is not shown in FIGS. 4-6 but a side view of a representative embodiment is depicted in FIG. 8.

Cutting line 100 includes horizontal payoff (not shown), cutting line main table 130, and at least one tub 140. If desired, a control unit may be located anywhere on cutting line 100 or even located remotely. Horizontal payoff is adapted to receive the spool of cable. Horizontal payoff may be driven or not driven. When driven, Horizontal payoff may include driving mechanism such as a motor to turn horizontal payoff and thereby unspool the cable for use in cutting line main table 130. When not driven, horizontal payoff may turn and unspool the cable as the cable is pulled by cutting line main table 130. Of course, it should be understood that other payoffs such as a lazy susan could also be employed.

Horizontal payoff is operatively connected to cutting line main table 130. Cutting line main table 130 is adapted to receive the cable from horizontal payoff and shear the cable to form a strand. In certain embodiments, cutting line main table 130 includes catapuller 132 and shear 134.

Catapuller 132 may be any mechanism adapted to pull the cable from horizontal payoff or other payoff and feed the cable to shear 134. As described in US 2022/0219348 which is incorporated by reference herein, catapuller 132 may include catapuller bodies separated by a gap through which the cable may be pulled by catapuller 132. Each catapuller body includes a drive mechanism which may be a drive wheel and retaining wheel.

Shear 134 may include at least one sharp edge for cutting or shearing the cable to form the strand. In certain embodiments, shear 134 may include a rotating blade and a fixed blade. Shear 134 may be operated manually, electrically, pneumatically, or hydraulically, for example.

In certain embodiments, cutting line main table 130 may include roller box 131. Roller box 131 may align the cable upstream of catapuller 132.

Cutting line main table 130 may include line counter 135. Line counter 135 may measure the length of the cable as pulled through catapuller 132. In addition, in certain embodiments, cutting line main table 130 may include tub selector 136, such as when cutting line 100 includes more than one tub 140. Tub selector 136 determines which of the plurality of tubs 140 the strand is to be transferred.

Cutting line 100 may include one or more tubs 140. One or more tubs 140 are operatively connected to and adapted to receive the strand from cutting line main table 130 and spool the strand. In the non-limiting embodiment shown in FIG. 4, tubs 140 include tub base 142 and strand receiving area 144. Tub base 142 may rotate so as to spool strands received from cutting line main table 130. Rotation of tub base 142 may be driven, i.e., turned manually, electrically, pneumatically, or hydraulically. Strand receiving area 144 may include one or more sides 146 to hold the strand spool in place.

Cutting line 100 may also include a power source and be operatively connected to, horizontal payoff, cutting line main table 130, and tubs 140. The power source may be configured to power a movable seater station 150 or movable seater station 150 may be independently powered. Power source may supply electrical power, air for pneumatic power, or hydraulic power. In certain embodiments, power source is electricity or a generator for providing electrical power.

Cutting line 100 may include movable seater station 150 which may also be referred to as a moveable dead end seater. Movable seater station 150 may be used to fasten an anchor to one end of the strand and advantageously may be configured to move from one tub to another as strands are produced that are in need of an anchor. In some embodiments cutting line 100 is configured with an auto-tying machine 200. Such a machine places ties on the coiled tendon so that it does not have unwanted uncoiling. Each tub may be configured to coil a tendon and form a tendon bundle which is tied. The tying may be accomplished in any convenient manner such as by an auto-tying machine 200 that is configured to place at least 3, or at least 4, or at least 5 up to 6 or up to 8 ties on each coil, i.e., bundle.

In some embodiments cutting line 100 is configured with a manipulator 300. Manipulator 300 may be configured to move and hang coils on a portable rack. The manipulator 300 may make cutting line 100 even more automated and efficient.

### REPRESENTATIVE EMBODIMENTS

1. An automated system for manufacturing post-tension tendons, comprising:
(a) a conveyor configured to introduce a first pre-determined length of a first tendon into a first tub;
(b) a cutter configured to cut the first tendon when it meets the first pre-determined length;
(c) a second tub operatively connected to the conveyer wherein the conveyor is configured to introduce a second pre-determined length of a second tendon into the second tub after the first tendon is cut and wherein a second cutter is configured to cut the second tendon when it meets the second pre-determined length; and
(d) a control unit configured for a user to input the first and second pre-determined lengths and a pre-determined bundle diameter wherein the control until is operably connected to the conveyer, the first and second cutter and to the first and second tub; and
wherein the first tub is configured to coil the first tendon to form a tendon bundle and tie the coiled first tendon bundle in the predefined bundle diameter and wherein the second tub is configured to coil the second tendon to form a second tendon bundle and tie the coiled second tendon bundle in the predefined bundle diameter.
2. The automated system for manufacturing post-tension tendons of embodiment 1, wherein the first and second pre-determined lengths are the same.
3. The automated system for manufacturing post-tension tendons of embodiment 1, wherein the first and second pre-determined lengths are different.
4. The automated system for manufacturing post-tension tendons of embodiment 1 which further comprises a movable seater station configured to fasten an anchor to at least one end of the first tendon, the second tendon or both.
5. The automated system for manufacturing post-tension tendons of embodiment 4 wherein the movable seater station is operably connected to the control unit.
6. The automated system for manufacturing post-tension tendons of embodiment 5 wherein said seater station is configured to move between the first tub and the second tub upon receipt of a command from the control unit.
7. The automated system for manufacturing post-tension tendons of embodiment 1 which further comprises a manipulator configured to move and hang the coiled tendon.
8. The automated system for manufacturing post-tension tendons of embodiment 7 wherein the manipulator is operably connected to the control unit.
9. The automated system for manufacturing post-tension tendons of embodiment 8 wherein said manipulator is configured to move between the first tub and the second tub upon receipt of a command from the control unit.
10. An automated system for manufacturing post-tension tendons, comprising:
(a) a conveyor configured to introduce a pre-determined length of a tendon into a tub;
(b) a cutter configured to cut the tendon when it meets the pre-determined length; and
(c) a control unit configured for a user to input the pre-determined length and a pre-determined bundle diameter wherein the control until is operably connected to the cutter, the conveyer, and to the tub; and wherein the tub is configured to coil the tendon to form a tendon bundle and tie the tendon bundle in the predefined bundle diameter.
11. An automated system for manufacturing post-tension tendons, comprising:
(a) a conveyor configured to introduce a pre-determined length of a tendon into a tub;
(b) a cutter configured to cut the tendon when it meets the pre-determined length;
(c) a control unit; and
(c) a movable seater station operably connected to the control unit wherein the movable seater station is configured to fasten an anchor to one end of a cut tendon wherein said movable seater station may be configured to move among two or more tubs upon receiving a command from the control unit.
12. An automated system for manufacturing post-tension tendons, comprising:
(a) a conveyor configured to introduce a pre-determined length of a tendon into a tub;
(b) a cutter configured to cut the tendon when it meets the pre-determined length;
(c) a control unit; and
(d) a manipulator operably connected to the control unit wherein the manipulator is configured to move and hang coiled tendons upon receiving a command from the control unit.

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

We claim:

1. An automated system for manufacturing post-tension tendons, comprising:
(a) a conveyor configured to introduce a first pre-determined length of a first tendon into a first tub;
(b) a cutter configured to cut the first tendon when it meets the first pre-determined length;
(c) a second tub operatively connected to the conveyer wherein the conveyor is configured to introduce a second pre-determined length of a second tendon into the second tub after the first tendon is cut and wherein a second cutter is configured to cut the second tendon when it meets the second pre-determined length; and
(d) a control unit configured for a user to input the first and second pre-determined lengths and a pre-determined bundle diameter wherein the control until is operably connected to the conveyer, the first and second cutter and to the first and second tub; and
wherein the first tub is configured to coil the first tendon to form a tendon bundle and tie the coiled first tendon bundle in the predefined bundle diameter and wherein the second tub is configured to coil the second tendon to form a second tendon bundle and tie the coiled second tendon bundle in the predefined bundle diameter.

2. The automated system for manufacturing post-tension tendons of claim 1, wherein the first and second pre-determined lengths are the same.

3. The automated system for manufacturing post-tension tendons of claim 1, wherein the first and second pre-determined lengths are different.

4. The automated system for manufacturing post-tension tendons of claim 1 which further comprises a movable seater station configured to fasten an anchor to at least one end of the first tendon, the second tendon or both.

5. The automated system for manufacturing post-tension tendons of claim 4 wherein the movable seater station is operably connected to the control unit.

6. The automated system for manufacturing post-tension tendons of claim 5 wherein said seater station is configured to move between the first tub and the second tub upon receipt of a command from the control unit.

7. The automated system for manufacturing post-tension tendons of claim 1 which further comprises a manipulator configured to move and hang the coiled tendon.

8. The automated system for manufacturing post-tension tendons of claim 7 wherein the manipulator is operably connected to the control unit.

9. The automated system for manufacturing post-tension tendons of claim 8 wherein said manipulator is configured to move between the first tub and the second tub upon receipt of a command from the control unit.

10. An automated system for manufacturing post-tension tendons, comprising:
(a) a conveyor configured to introduce a pre-determined length of a tendon into a tub;
(b) a cutter configured to cut the tendon when it meets the pre-determined length; and
(c) a control unit configured for a user to input the pre-determined length and a pre-determined bundle diameter wherein the control until is operably connected to the cutter, the conveyer, and to the tub; and wherein the tub is configured to coil the tendon to form a tendon bundle and tie the tendon bundle in the predefined bundle diameter.

11. An automated system for manufacturing post-tension tendons, comprising:
(a) a conveyor configured to introduce a pre-determined length of a tendon into a tub;
(b) a cutter configured to cut the tendon when it meets the pre-determined length;
(c) a control unit; and
(c) a movable seater station operably connected to the control unit wherein the movable seater station is configured to fasten an anchor to one end of a cut tendon wherein said movable seater station may be configured to move among two or more tubs upon receiving a command from the control unit.

12. An automated system for manufacturing post-tension tendons, comprising:
(a) a conveyor configured to introduce a pre-determined length of a tendon into a tub;
(b) a cutter configured to cut the tendon when it meets the pre-determined length;
(c) a control unit; and
(d) a manipulator operably connected to the control unit wherein the manipulator is configured to move and hang coiled tendons upon receiving a command from the control unit.
